(19) United States
(12) Patent Application Publication
(10) Pub. No.: US 2020/0301318 A1
(43) Pub. Date: Sep. 24, 2020

(54) IMAGE FORMING APPARATUS

(71) Applicant: Konica Minolta, Inc., Tokyo (JP)

(72) Inventors: Yoshiki NAKANE, Tokyo (JP); Kei OKAMURA, Tokyo (JP); Hiroshi MORIMOTO, Tokyo (JP); Natsuko MINEGISHI, Tokyo (JP); Takenobu KIMURA, Tokyo (JP)

(21) Appl. No.: 16/824,743

(22) Filed: Mar. 20, 2020

(30) Foreign Application Priority Data
Mar. 22, 2019 (JP) 2019-055167

(51) Int. Cl. G03G 15/16; G03G 21/10; G03G 21/00

(52) U.S. Cl. CPC G03G 15/161; G03G 21/0011; G03G 21/10

(57) ABSTRACT

An image forming apparatus including: an image carrier that carries a toner image; a cleaner that contacts a surface of the image carrier and removes a toner, the cleaner being located at a first position during stop of rotation of the image carrier and located at a second position during rotation of the image carrier; a moving mechanism that moves the cleaner between the first position and the second position by moving the cleaner in a direction parallel to a rotation shaft of the image carrier while maintaining a contact state between the cleaner and the image carrier; and a hardware processor, in which the hardware processor starts to move the cleaner from the first position to the second position with the moving mechanism during stop of the rotation of the image carrier, and the hardware processor starts to rotate the image carrier during movement of the cleaner.

### CROSS-REFERENCE TO RELATED APPLICATIONS

The present invention claims priority under 35 U.S.C. §119 to Japanese Patent Application No. 2019-055167 filed on Mar. 22, 2019, the entire content of which is incorporated herein by reference.

### BACKGROUND

### Technological Field

The present invention relates to an image forming apparatus.

### Description of the Related Art

Conventionally, in the image forming apparatus employing the electro-photographic method, there is known the cleaning device of the blade cleaning method as a means for removing residual toner on a photoconductor as an image carrier such as non-transferred toner and transfer residual toner, the cleaning device having a cleaning blade of a flat plate that includes an elastic body contact the surface of the photoconductor and thereby removing the residual toner on the photoconductor, for example.

Since the cleaning blade needs the ability to scrape the toner on the photoconductor, rubber materials which highly stick to the photoconductor and have large coefficients of friction are generally used. However, when a material such as a rubber material having a large coefficient of friction is used, a large frictional force is generated between the material and the photoconductor in accordance with the rotation of the photoconductor.

For example, when the frictional force increases in accordance with stop of the rotation of the photoconductor, noise and cleaning defects may occur due to the stick-slip phenomenon of repeating stopping and slipping by the friction. In view of the above problems, JP 2013-195993A causes the cleaning blade to perform reciprocating movement along the shaft direction of the photoconductor in the process of stopping the rotation of the photoconductor, and thereby improves the relative speed of the cleaning blade with respect to the photoconductor, to solve the above problems.

### SUMMARY

Generally, since the static friction force is larger than the dynamic friction force, the largest load is applied on the cleaning blade at the time when the photoconductor starts rotating.

By the large static friction force being applied, there occurs “turn-up” that the cleaning blade is drawn in the rotation direction of the photoconductor and turns. Moreover, there has been a problem that, in order to rotate the photoconductor resisting the static friction force, a motor having a large rated torque is necessary, leading to the increase in size of the image forming apparatus.

Though the image forming apparatus described in JP 2013-195993A can cope with the problems occurring in accordance with the stop of rotation of the photoconductor, the problems at the time of starting the rotation still occur.

The present invention has been made in consideration of the above problems, and an object of the present invention is to provide an image forming apparatus that can reduce the frictional force generated in accordance with the start of rotation of the image carrier.

To achieve at least one of the abovementioned objects, according to an aspect of the present invention, an image forming apparatus reflecting one aspect of the present invention includes: an image carrier that carries a toner image to be transferred to a sheet; a cleaner that contacts a surface of the image carrier and removes a toner, the cleaner being located at a first position while a rotation of the image carrier is stopped and the cleaner being located at a second position during the rotation of the image carrier; a moving mechanism that moves the cleaner between the first position and the second position by moving the cleaner in a direction parallel to a rotation shaft of the image carrier while a contact state between the cleaner and the image carrier is maintained; and a hardware processor that controls operations of the image carrier and the moving mechanism, wherein the hardware processor starts a movement of the cleaner from the first position to the second position with the moving mechanism while the rotation of the image carrier is stopped, and the hardware processor starts the rotation of the image carrier during the movement of the cleaner.

### BRIEF DESCRIPTION OF THE DRAWINGS

The advantages and features provided by one or more embodiments of the invention will become more fully understood from the detailed description given hereinafter and the appended drawings which are given by way of illustration only, and thus are not intended as a definition of the limits of the present invention, and wherein:

FIG. 1 is a diagram showing a schematic configuration of an image forming apparatus according to the present invention;

FIG. 2 is a block diagram showing a functional configuration of the image forming apparatus;

FIG. 3 is a view showing a schematic configuration around an image former;

FIG. 4 is a view showing a schematic configuration of end seal members;

FIGS. 5A to 5C are views each showing a schematic configuration of a moving mechanism;

FIG. 6 is a timing chart of the operation of each component of the image former;

FIG. 7 is a view showing the drive torque of a photoconductor in the image forming apparatus according to the embodiment;

FIGS. 8A and 8B are views each showing the shape of an end of a cleaning blade;

FIG. 9 is a view showing a pressing amount of the cleaning blade with respect to the end seal members;

FIG. 10 is a view for explaining the effects of examples of the present invention; and

FIG. 11 is a view showing the drive torque of a photoconductor in a conventional image forming apparatus.

### DETAILED DESCRIPTION OF EMBODIMENTS

Hereinafter, one or more embodiments of the present invention will be described with reference to the drawings. However, the scope of the invention is not limited to the disclosed embodiments.

[Configuration of Image Forming Apparatus]

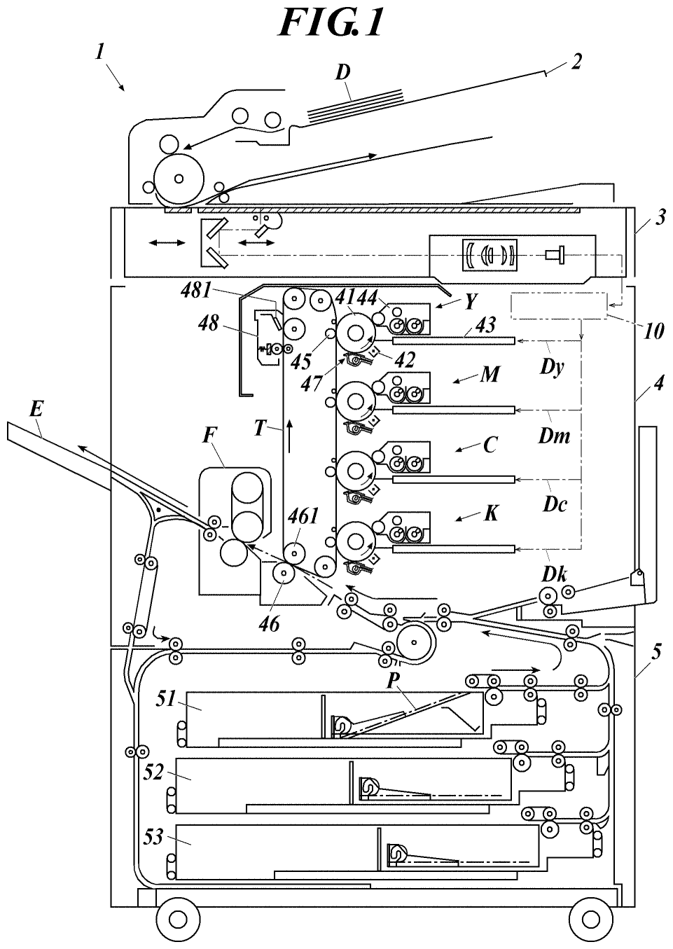

The image forming apparatus 1 according to the present embodiment is a color image forming apparatus employing an intermediate transfer method which uses an electro-photographic process technique. As shown in FIG. 1 to FIG. 3, the image forming apparatus 1 includes an automatic document conveyor 2, a scanner 3, an image former 4, a sheet feeder 5, a storage 6, an operation/display unit 7, a controller 10 (hardware processor), and the like.

The automatic document conveyor 2 includes a placement tray to place a document D, a mechanism and conveying rollers to convey the document D and the like to convey the document D to a predetermined conveying path.

The scanner 3 is provided with an optical system such as an optical source and a reflecting mirror, the optical source irradiates the document D conveyed on the predetermined conveying path or the document D placed on a platen glass and the scanner 3 receives the reflected light. The scanner 3 converts the received reflected light to an electric signal and outputs the electric signal to the controller 10.

The image former 4 includes a yellow imager Y, a magenta imager M, a cyan imager C, a black imager K, an intermediate transfer belt T, and a fixer F.

Each imager YMCK forms a toner image in yellow, magenta, cyan, or black, respectively, on a photoconductor 41, and the toner images in the colors YMCK formed on the photoconductor 41 are transferred by primary transfer on the intermediate transfer belt T.

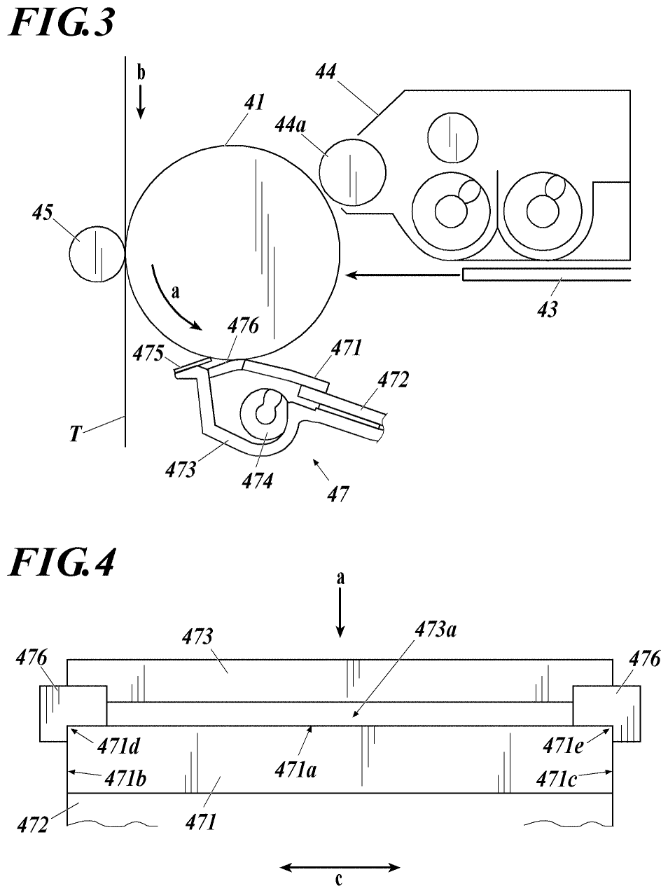

FIG. 3 is a diagram showing a schematic configuration of an image former 4. Each imager includes the following, the drum shaped photoconductor 41 (image carrier) which is driven to rotate in a direction a as shown in the diagrams, a charging device 42 which uniformly charges the surface of the photoconductor 41, an exposing device 43 which exposes the surface of the photoconductor 41 charged by the charging device 42 to form an electrostatic latent image, a developing device 44 which uses a developer including toner to visualize the electrostatic latent image formed by the exposing device 43, a primary transfer roller 45 which transfers the toner image formed on the photoconductor 41 onto a sheet, a cleaning device 47 which removes the toner on the photoconductor 41 that passed a transfer region, and a belt cleaning device 48 (refer to FIG. 1) which removes the transfer residual toner on the intermediate transfer belt T. The toner image formed on the photoconductor 41 is transferred by primary transfer onto the intermediate transfer belt T moving in the direction b as shown in the drawing. The toner image transferred onto the intermediate transfer belt T is transferred to the sheet by the secondary transfer roller 46. Then, the sheet is conveyed to the fixer F, and the toner image is fixed on the sheet.

The configuration and the operation are the same for all imagers YMCK. Therefore, hereinbelow, the flow of the image forming operation performed by the image former 4 is described with reference to the yellow imager Y as the example.

The photoconductor 41 includes an organic photoconductor in which a photoconductor layer is formed including a resin containing an organic photoconductive material on an outer circumferential surface of a drum-shaped metallic base. The photoconductor 41 is driven to rotate in the direction a shown in the drawing. The resin included in the photoconductor layer may be polycarbonate resin, silicone resin, polystyrene resin, acrylic resin, methacrylic resin, epoxy resin, polyurethane resin, vinyl chloride resin, melamine resin, for example.

The photoconductor 41 includes a layer structure in which an undercoat layer (UCL), a charge generation layer (CGL), and a charge transport layer (CTL) are positioned in this order on a conductive original tube such as an aluminum tube.

The charging device 42 uses a charger to charge the photoconductor 41 to a certain electric potential in a minus polarity.

The exposing device 43 exposes a non-image region of the photoconductor 41 based on image data Dy from the controller 10 to remove the charge of the exposed portion and forms the electrostatic latent image in the image region of the photoconductor 41.

Specifically, on the surface of the photoconductor 41 charged to the minus polarity by the charging device 42, electric charges are removed by exposure of the exposing device 43. When both of positive and negative electric charges are generated in the charge generation material in CGL, the positive charge (hole) passes through CTL to reach the surface of the photoconductor 41, and the negative charge passes through UCL to reach the original tube. Thereby, the electrostatic latent image is formed on the surface of the photoconductor 41.

The developing device 44 includes a developing sleeve 44a positioned facing the photoconductor 41 with the developing region in between. For example, a developing bias with an AC voltage superimposed on a DC voltage with a same polarity as the charging polarity of the charging device 42, that is, a DC voltage with a minus polarity, is applied to the developing sleeve 44a. With this, the developer is supplied on the electrostatic latent image formed on the photoconductor 41, and the yellow toner image is formed on the photoconductor 41. The developer includes a toner and a carrier to charge the toner.

The toner is not limited and well-known toner which is widely used can be used. For example, it is possible to use a binder resin which includes a colorant and as necessary, a charge controlling agent or a separating agent and which is processed with an external additive. The toner particle size is not limited, and preferably, the size is about 3 to 15 μm.

Primary transfer is performed by using the primary transfer roller 45 to transfer the yellow toner image formed on the photoconductor 41 onto the intermediate transfer belt T. Similarly for the imagers MCK, primary transfer is performed to transfer the toner images in magenta, cyan, and black onto the intermediate transfer belt T. With this, the toner images with the colors YMCK are formed on the intermediate transfer belt T.

The intermediate transfer belt T is a semi-conductive endless belt hung around a plurality of rollers to be supported in a rotatable state. The intermediate transfer belt T is rotated in the direction b as shown in the drawing in accordance with the rotation of the rollers. The intermediate transfer belt T is pressed against the opposing photoconductor 41 by the primary transfer roller 45. The transfer electric current according to the applied voltage flows in each primary transfer roller 45. With this, primary transfer is performed and each of the toner images developed on the surface of each photoconductor 41 is successively transferred to the intermediate transfer belt T by the primary transfer roller 45.

The secondary transfer roller 46 is pressed by the intermediate transfer belt T and rotates in a manner following the intermediate transfer belt T. With this, the secondary transfer is performed and the toner images in the colors YMCK transferred and formed on the intermediate transfer belt T are transferred on a sheet(s) of paper P conveyed from sheet feeding trays 51 to 53 of the sheet feeder 5. In detail, the secondary transfer roller 46 is positioned in contact with the secondary transfer opposing roller 461 with the intermediate transfer belt T in between. When the paper P passes a transfer nip formed between the secondary transfer roller 46 and the secondary transfer opposing roller 461, the secondary transfer is performed and the toner image on the intermediate transfer belt T is transferred onto the paper P.

The toner which is not transferred on the intermediate transfer belt T in the transfer region and which remains on the photoconductor 41 is transferred to the cleaning device 47 and collected by the cleaning device 47. The detailed configuration of the cleaning device 47 will be described later.

The photoconductor 41 in which the toner on the surface is collected by the cleaning device 47 is charged again by the charging device 42 and the next electrostatic latent image is formed to form the toner image. This process is repeated.

The belt cleaning device 48 includes a belt cleaning blade 481 which rubs against the surface of the intermediate transfer belt T and the like, and removes the transfer residual toner which remains on the surface of the intermediate transfer belt T after secondary transfer.

The image former 4 uses the fixer F to heat and pressure the paper P on which the toner images in the colors YMCK are transferred by secondary transfer and then passes the paper P through the predetermined conveying path to eject the paper P outside the apparatus.

The flow of processes described above is the image forming process performed by the image former 4.

The sheet feeder 5 includes a plurality of sheet feeding trays 51 to 53, and a plurality of different types of paper P are stored in each sheet feeding tray 51 to 53. The sheet feeder 5 feeds the stored paper P to the image former 4 through the predetermined conveying path.

The storage 6 includes an HDD (Hard Disk Drive), a semiconductor memory, and the like, and stores data such as the program data and various setting data in a readable and writable state under the control of the controller 10.

The operation/display unit 7 includes a liquid crystal display (LCD) with a touch panel and functions as a display 71 and an operation unit 72.

The display 71 displays various operation screens and an operation status of various functions according to a display control signal input from the controller 10. The display 71 receives touch operation by the user and outputs the operation signal to the controller 10.

The operation unit 72 includes various operation keys such as numeric keys and a start key, and the operation unit 72 receives various input operation by the user and outputs the operation signal to the controller 10. The user operates the operation/display unit 7 to be able to perform operation such as setting regarding the image forming including image quality setting, magnification setting, advanced setting, output setting, and paper setting, paper conveying instruction, and operation to stop the apparatus.

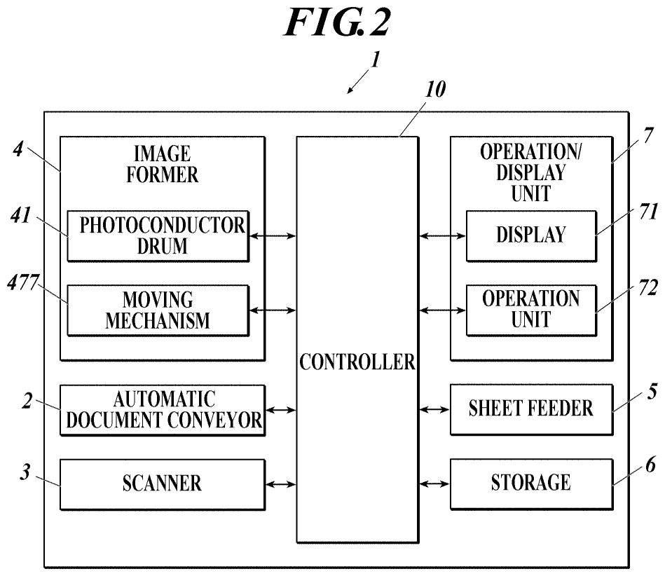

The controller 10 includes a CPU, a RAM, and a ROM. The CPU deploys various programs stored in the ROM to the RAM and in coordination with the various deployed programs, the controller 10 centrally controls the operation of various units in the image forming apparatus 1 such as the automatic document conveyor 2, scanner 3, image former 4, sheet feeder 5, storage 6, operation/display unit 7, and the like (refer to FIG. 2). For example, the electric signals are input from the scanner 3 and the controller 10 performs various image processes. The controller 10 outputs the image data Dy, Dm, Dc and Dk of the colors YMCK generated by image process to the image former 4. The controller 10 controls the operation of the image former 4 to form a test image on the sheet.

[Configuration of Cleaning Device]

Next, the configuration of the cleaning device 47 will be described in detail with reference to the drawings.

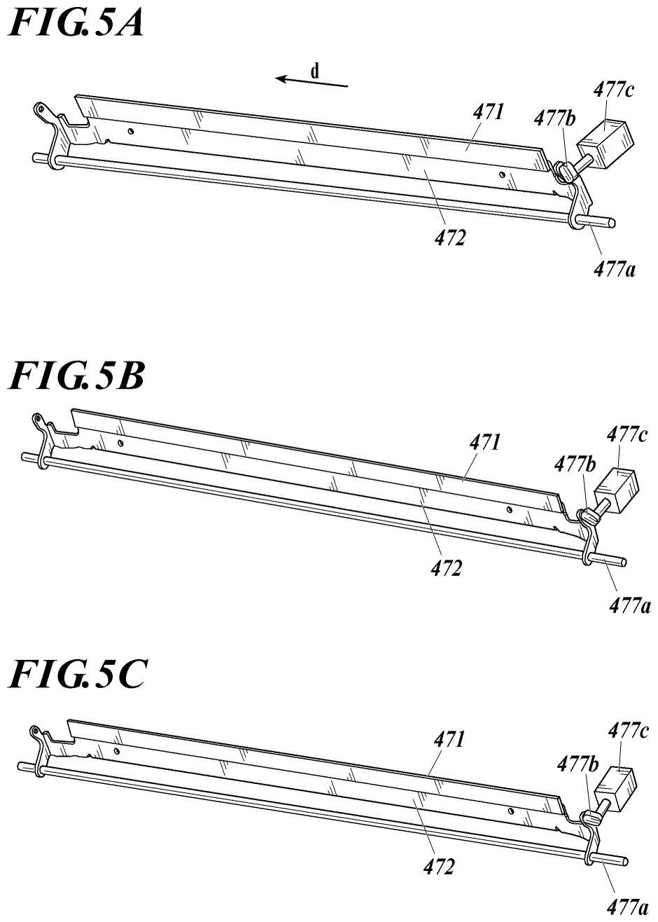

As shown in FIG. 3, the cleaning device 47 is configured by including: a cleaning blade 471; a holding member 472 which holds the cleaning blade 471; a housing 473 which is provided on the substantially lower side of the cleaning blade 471; a collection screw 474 which is provided on the substantially lower side of the cleaning blade 471 inside the housing 473; and an upstream seal member 475 which is joined to the housing 473 and provided on the upstream side of the cleaning blade 471 in the rotation direction a of the photoconductor 41. The cleaning device 47 further includes end seal members 476 (refer to FIG. 4) which are provided to contact both ends in the longitudinal direction of the cleaning blade 471; and a moving mechanism 477 (refer to FIGS. 5A to 5C).

The cleaning blade 471 is a member which is in a strip shape extending in the longitudinal direction parallel to the shaft direction of the photoconductor 41. The cleaning blade 471 has a function of scraping and removing the attached materials such as non-transferred toner remaining on the surface of the photoconductor 41. The cleaning blade 471 is, for example, an elastic body such as a urethane rubber with excellent abrasion resistance and ozone resistance, the elastic body being processed to be a flat shape. The cleaning blade 471 is positioned to make an end thereof rub against the surface of the photoconductor 41. The length in the longitudinal direction of the cleaning blade 471 is longer than the image forming region on the photoconductor 41. The length in the direction orthogonal to the longitudinal direction, that is, in the short direction is desirably 5 to 12 mm, but may be longer than 5 to 12 mm. The thickness of the cleaning blade 471 is desirably 0.5 to 2.0 mm, but not limited to 0.5 to 2.0 mm. When the cleaning blade 471 is formed with a metal mold, the thickness and the length in the short direction may be further reduced.

The cleaning blade 471 functions as a cleaner in the present invention.

The holding member 472 is a sheet metal which is fixed on the housing 473, and holds the cleaning blade 471 to contact the photoconductor 41. The distance between the photoconductor 41 and the cleaning blade 471 is defined by the position and the angle of the holding member 472 provided to the housing 473. The material of the holding member 472 is a steel sheet such as SECC, for example. The thickness of the holding member 472 may be desirably set to 1.6 to 2.0 mm in order to suppress the deformation by the pressure and external force applied to the cleaning blade 471 and secure the strength which enables requiring the edge straightness of the cleaning blade 471. In order to attach the holding member 472 to the cleaning blade 471, thermoplastic hot melt adhesive may be used, or double-sided tape may be used. When the cleaning blade 471 is formed, there may be used a manufacturing method of attaching the holding member 472 and the cleaning blade 471 by integral molding with a mold. In this case, the adhesive is not used.

The housing 473 is a housing which is arranged along the shaft direction of the photoconductor 41. The opening formed over the longitudinal direction of the cleaning blade 471 faces the photoconductor 41 to contain the toner scraped off by the cleaning blade 471. The housing 473 functions as a collector in the present invention.

The collection screw 474 is arranged inside the housing 473, and conveys the toner, which was scraped off by the cleaning blade 471 and fell down, with a waste toner box not shown in the drawings while rotating in one direction.

The upstream seal member 475 is a flat plate member formed of an elastic body, and fixed to the housing 473 so that an end of the upstream seal member 475 contacts the photoconductor 41. The upstream seal member 475 has a function of preventing the toner inside the housing 473 from splattering to the upstream side to make the photoconductor 41 dirty, by filling the gap between the housing 473 and the photoconductor 41.

Each of the end seal members 476 is a member formed of an elastic body such as urethane foam of the cleaning blade 471.

FIG. 4 is a view of the cleaning blade 471, the holding member 472, the housing 473 and the end seal members 476, seen from the side where the photoconductor 41 is arranged. In FIG. 4, the arrow c indicates the longitudinal direction of the cleaning blade 471 and the arrow a indicates the rotation direction of the photoconductor 41.

In the following description, the side extending in the longitudinal direction c of the cleaning blade 471 and contacting the surface of the photoconductor 41 is referred to as a first side 471a. The side located at one end of the longitudinal direction and orthogonal to the first side 471a is referred to as a second side 471b. The side located at the other end of the longitudinal direction and orthogonal to the first side 471a is referred to as a third side 471c. In the end portions in the longitudinal direction c of the cleaning blade 471, the end portion formed between the first side 471a and the second side 471b is referred to as a first end portion 471d, and the end portion formed between the first side 471a and the third side 471c is referred to as a second end portion 471e.

The end seal members 476 are two members which respectively contact the first end portion 471d and the second end portion 471e. The end seal members 476 are L-shaped members that are provided to contact the first side 471a and the second side 471b or the third side 473c respectively. The two end seal members 476 are pressed by the second side 471b or the third side 471c of the cleaning blade 471 respectively, and used in the crushed state.

As shown in FIG. 4, the housing 473 has an opening 473a which is open along the longitudinal direction c of the cleaning blade 471. When the photoconductor 41 rotates in the direction a, the plume of the toner which was scraped off by the cleaning blade 471 enters inside the housing 473 from the opening 473a. If the end seal members 476 are not provided, there is a concern that the toner may leak without entering the housing 473 from the gap between the cleaning blade 471 and the housing 473 around the first end portion 471d and the second end portion 471e. The end seal members 476 have a function of preventing the leakage of toner by contacting the first end portion 471d and the second end portion 471e to fill the gap between the cleaning blade 471 and the housing 473.

The moving mechanism 477 is a mechanism for moving the cleaning blade 471 between a first position and a second position to be described later, and configured by including a shaft 477a, cam 477b and a drive motor 477c.

Each of FIGS. 5A to 5C is a perspective view of the cleaning blade 471, the holding member 472 and the moving mechanism 477. As shown in FIGS. 5A to 5C, the shaft 477a that is provided to be parallel to the shaft direction of the photoconductor 41 is inserted through the holes provided at both ends of the holding member 472. The cam 477b contacts one end of the holding member 472 and the motor 477c for rotating the cam 477b is connected to the cam 477b.

When the motor 477c is rotated under control of the controller 10, the cam 477b rotates as shown in FIGS. 5A to 5C. FIG. 5A shows a state in which the holding member 472 contacts the portion of the cam 477b where the distance between the rotation center and the outer diameter of the cam 477b is smallest. Through the contact state with the portion of the cam 477b where the distance between the rotation center and the outer diameter of the cam 477b is intermediate as show in FIG. 5B, the state shifts to the state in which the holding member 472 contacts the portion of the cam 477b where the distance between the rotation center and the outer diameter of the cam 477b is largest. The cam 472b presses the holding member 472 in the direction indicated by the arrow d in the drawing, in accordance with the rotation. Thus, since the holding member 472 is moved in the direction of arrow d in the drawing along the shaft 477a, the cleaning blade 471 is also simultaneously moved in the direction d in the drawing. By adjusting the rotation speed of the motor 477c, the shape of the cam 477b and the like, it is possible to move the cleaning blade 471 at an arbitrary speed.

When the holding member 472 is to be moved to the opposite direction to the moving direction by the rotation of the cam 477b, it is effective to provide a biasing means which presses the holding member 472. That is, a biasing means such as a coil spring not shown in the drawings is provided to the end which does not contact the cam 477b among the ends in the longitudinal direction of the holding member 472, to bias the holding member 472 in the opposite direction to the moving direction by rotation of the cam 477b. Thus, when the cam 477b is returned from the position of FIG. 5C to the position of FIG. 5A, the cleaning blade 471 can also be returned to the position of FIG. 5A.

[Movement of Cleaning Blade]

The movement of the cleaning blade 471 will be described with reference to the drawings. As a feature of the cleaning blade 471 in the present embodiment, before start of rotation of the photoconductor 41, the contact state between the photoconductor 41 and the cleaning blade 471 is maintained and the cleaning blade 471 is moved in the direction parallel to the rotation shaft of the photoconductor 41, and thereby the cleaning blade 471 is moved between the first position and the second position.

A material such as rubber having a high adhesion to the photoconductor 41 and a high coefficient of friction is used for the cleaning blade 471. Thus, a large friction is generated between the photoconductor 41 and the cleaning blade 471 in accordance with the rotation of the photoconductor 41.

FIG. 11 is a view showing the drive torque generated in a photoconductor in a conventional image forming apparatus. As the drive torque is larger, the friction force between the photoconductor 41 and the cleaning blade 471 is larger. The drive torque shown in FIG. 11 is the value obtained by setting a torque measuring instrument between the photoconductor 41 and the drive motor rotating the photoconductor 41 and measuring the drive torque of the photoconductor 41.

As shown in FIG. 11, the static friction force is generated from the time indicated by t1 in the drawing when the drive torque for rotating the photoconductor 41 starts to be applied. After the static friction force increases to apply the maximum static friction force, the photoconductor 41 starts to rotate. Thereafter, the dynamic friction force acts until the time when the rotation of the photoconductor 41 is stopped indicated by t2 in the drawing. As generally known, the static friction force is large compared to the dynamic friction force. Accordingly, the image forming apparatus 1 according to the embodiment reduces the load on the cleaning blade 471 by moving the cleaning blade 471 in the shaft direction of the photoconductor 41 and thereby generating the dynamic friction force, not the static friction force, before start of the rotation of the photoconductor 41, in order to prevent turn-up of the cleaning blade 471 caused by the static friction force.

That is, when the position where the cleaning blade 471 is arranged while the rotation of the photoconductor 41 is stopped is referred to as a first position, and the position where the cleaning blade 471 is arranged during the rotation of the photoconductor 41 is referred to as a second position, the cleaning blade 471 starts to move from the first position to the second position before start of the rotation of the photoconductor 41. During the movement of the cleaning blade 471, the photoconductor 41 starts to rotate.

FIG. 6 is a timing chart showing the timing of movement of the cleaning blade 471. The “rotation signal” shown in the drawing indicates the signal that the controller 10 outputs to the photoconductor 41 in order to rotate the photoconductor 41. The “movement signal” indicates the signal that the controller 10 outputs to the moving mechanism 477 in order to move the cleaning blade 471 with the moving mechanism 477.

As shown in FIG. 6, the movement signal and the rotation signal are signals independent from each other. Since the movement signal is input before the rotation signal of the photoconductor 41 is input, the movement signal is input before start of the rotation of the photoconductor 41, and thereby the cleaning blade 471 starts to move along the shaft direction of the photoconductor 41. Since the rotation signal of the photoconductor 41 is input while the movement signal is input, the photoconductor 41 starts to rotate during the movement of the cleaning blade 471.

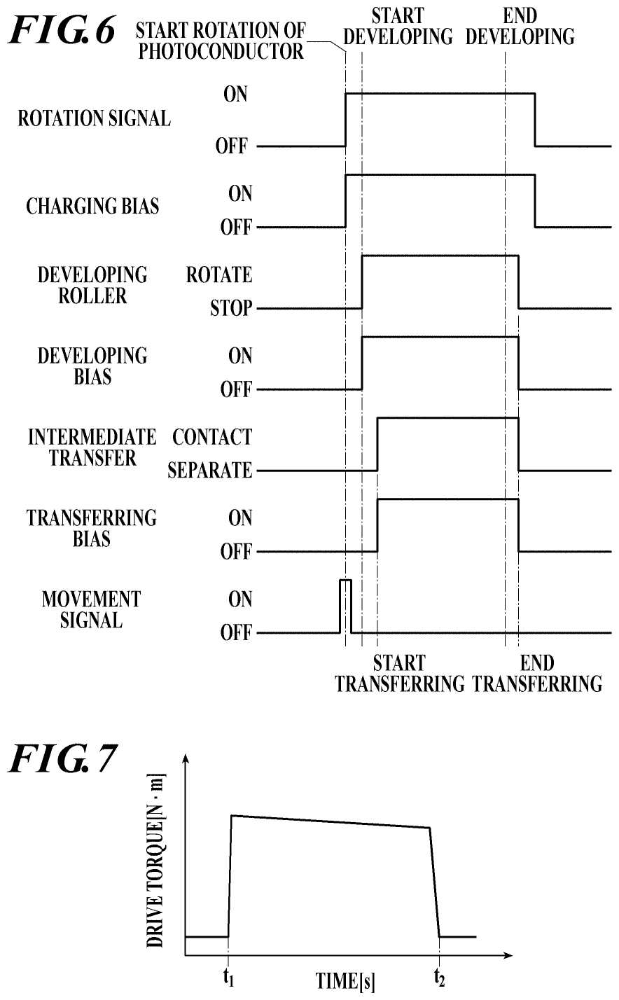

FIG. 7 is a view showing the drive torque of the photoconductor 41 when the cleaning blade 471 is moved at the time when the rotation of the photoconductor 41 starts.

When the rotation of photoconductor 41 starts, the cleaning blade 471 is moving in the shaft direction of the photoconductor 41, and thus the dynamic friction force, not the static friction force, acts between the photoconductor 41 and the cleaning blade 471. Accordingly, it is possible to reduce the friction force compared to the conventional image forming apparatus and reduce the drive torque necessary for rotating the photoconductor 41.

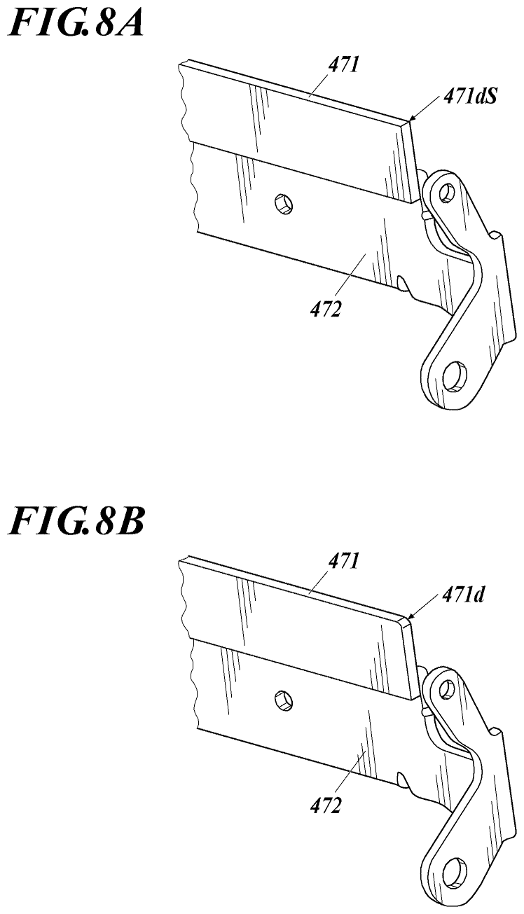

The shape of the end in the longitudinal direction of the cleaning blade 471 will be described by using FIGS. 8A and 8B. Even when the cleaning blade 471 is moved in the shaft direction of the photoconductor 41, the static friction force is generated in the opposite direction to the moving direction of the cleaning blade 471. Accordingly, it is effective to make the end in the longitudinal direction of the cleaning blade 471 in a shape that enables reduction of the static friction force.

FIG. 8A is a view showing a first end portion 471dS having a square shape of the cleaning blade 471 in the image forming apparatus 1. In the image forming apparatus 1 in the embodiment, as shown in FIG. 8B, the first end portion 471d of the cleaning blade 471 has a round shape. By having a round shape at the distal end in the moving direction in such a way, it is possible to reduce the static friction force compared to the cleaning blade having a square shape as shown in FIG. 8A. In consideration that the cleaning blade 471 is moved in both directions between the first position and the second position, it is desirable that both of the first end portion 471d and the second end portion 471e have round shapes.

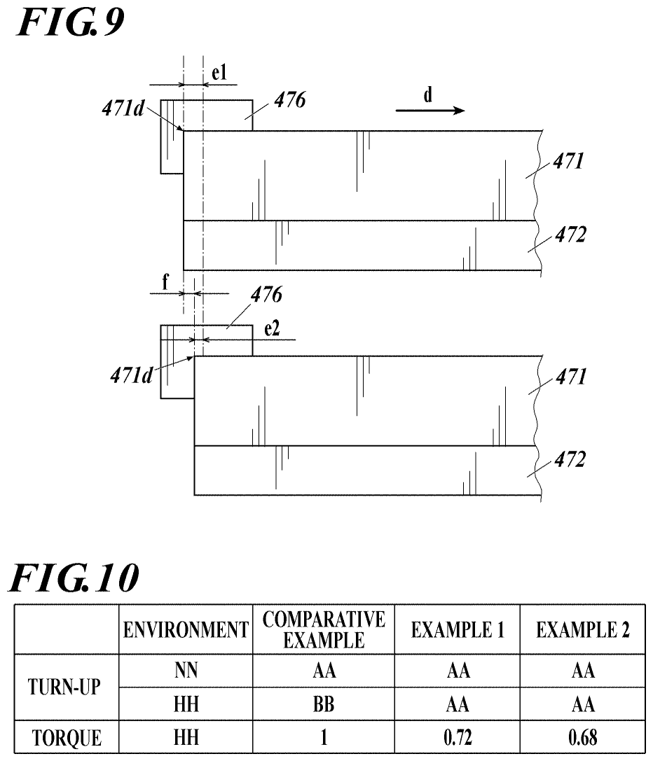

The pressing amount to each of the end seal members 476 of the cleaning blade 471 will be described by using FIG. 9.

As mentioned above, the first end portion 471d and the second end portion 471e of the cleaning blade 471 are arranged to be pressed to the end seal members 476 respectively. In the following description, the position of the cleaning blade 471 shown in the upper section of FIG. 9 is referred to as a first position, the position of the cleaning blade 471 shown in the lower section of FIG. 9 is referred to as a second position, and the pressing amount to the end seal member 476 of the first end portion 471d when arranged at the first position is referred to as el. The movement amount when the cleaning blade 471 is moved from this state to the second position, that is, when the cleaning blade 471 is moved in the direction indicated by the arrow d in the drawing is referred to as f.

The movement amount f is smaller than the pressing amount e1, and the pressing amount e2 is secured even when the cleaning blade is moved to the second position. When the movement amount f is equal to or larger than the pressing amount e1, the seal function of the end seal member 476 is not sufficient, and the splattering of the collected toner cannot be prevented sufficiently. Similarly, the second end portion 471e is arranged so that the pressing amount of the second end portion 471e to the end seal member 476 is secured even when the cleaning blade 471 is moved from the second position to the first position.

That is, the arrangement is made so that both of the first end portion 471d and the second end portion 471e are pressed to the end seal members 476 whichever position of the first position and the second position the cleaning blade 471 is located at.

The first position where the cleaning blade 471 is located while the rotation of the photoconductor 41 is stopped and the second position where the cleaning blade 471 is located during the rotation of the photoconductor 41 may be switched to each other each time the photoconductor 41 is stopped, or may be always remain the same positions regardless of the rotation state of the photoconductor 41.

When the first position and the second position are switched to each other and the first position is the position of the cleaning blade 471 when the cleaning blade 471 is moved to the first end portion 471d side and the second position is the position of the cleaning blade 471 when the cleaning blade 471 is moved to the second end portion 471e side in the first job, the cleaning blade 471 maintains the state of stopping at the second position after the first job is completed and the photoconductor 41 is stopped. When the second job is started, the second position in the first job, that is, the position of the cleaning blade 471 when the cleaning blade 471 is moved to the second end portion 471e becomes the first position in the second job. Before start of the rotation of the photoconductor 41, the cleaning blade 471 is moved from the second end portion 471e to the first end portion 471d. During the rotation of photoconductor 41, the cleaning blade 471 is fixed and held at the second position.

In this configuration, by both of the first end portion 471d and the second end portion 471e having round shapes, it is possible to sufficiently obtain the reduction effect of the static friction force.

On the other hand, when the first position and the second position are always the same positions, for example, when the first position is always the position of the cleaning blade 471 when the cleaning blade 471 is moved to the first end portion 471d side, and the second position is always the position of the cleaning blade 471 when the cleaning blade 471 is moved to the second end portion 471e side, in all the jobs, the cleaning blade 471 is moved in the direction from the first end portion 471d to the second end portion 471e before start of the rotation of the photoconductor 41. In the first job, when the cleaning blade 471 is moved from the second position to the first position at any timing during the rotation of the photoconductor 41, it is possible to move the cleaning blade 471 from the first position to the second position at the time when the second job is started.

In this configuration, it is desirable to have a round shape for at least the end portion (second end portion 471e in the above example) located at the distal end side in the moving direction from the first position to the second position among the first end portion 471d and the second end portion 471e.

When the operation of the image former 4 makes the emergency stop for reasons such as paper jam and door opening during the movement of the cleaning blade 471, it is not possible to determine whether the cleaning blade 471 is located at the first position or the second position, or whether the cleaning blade 471 is not located at either position. For such a case, it is effective to provide a position detector that can detect the position of the cleaning blade 471 and move the cleaning blade 471 to a predetermined position before restart of the rotation of the photoconductor 41. As the position detector, a general optical sensor can be used. By detecting a projection provided on the cleaning blade 471 with the optical sensor, it is possible to detect the position of the cleaning blade 471.

### EXAMPLES

Hereinafter, the present invention will be described in detail by taking examples. However, the present invention is not limited to these examples.

The effects of the reduction in the static friction force in image forming apparatuses 1 to which the present invention is applied were verified with the following method.

### Comparative Example

The comparative example adopted the configuration of the conventional image forming apparatus. That is, in the comparative example, the movement of cleaning blade in accordance with the start of rotation of the photoconductor was not performed.

### Example 1

The example 1 adopted the configuration of the image forming apparatus 1 to which the present invention is applied. That is, in the example 1, the cleaning blade 471 was moved along the shaft direction of the photoconductor 41 before start of the rotation of the photoconductor 41, and the rotation of the photoconductor 41 was started during the movement of the cleaning blade 471. The cleaning blade 471 had the first end portion 471dS and second end portion 471eS having square shapes.

### Example 2

The example 2 adopted the similar configuration to the configuration of the example 1. Furthermore, the first end portion 471d and the second end portion 471e of the cleaning blade 471 had round shapes.

### <Common Condition>

As the image forming apparatus 1, Konica Minolta Accurio Press C6100 which was modified was used. Though the cleaning blade 471 has the tolerance in a contact force and a contact angle, both of the contact force and the contact angle were set to have upper limit values. That is, the cleaning blade 471 was set under the condition easily causing the “turn-up” to occur.

In each of the comparative example, example 1 and example 2, the operation of outputting a single sheet of the document of coverage 0% was repeated fifty times in the NN environment (temperature 20° C., relative humidity 50%) and HH environment (temperature 30° C., relative humidity 80%).

### <Evaluation Result>

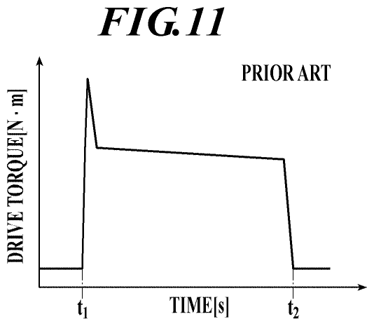

FIG. 10 shows the evaluation result of presence/absence of generation of turn-up in the comparative example, example 1 and example 2. In the drawing, AA indicates that the turn-up did not occur and BB indicates that the turn-up occurred. The “TORQUE” indicates the ratio of drive torque in each of the examples when the drive torque of the photoconductor 41 in the comparative example is 1.

As shown in FIG. 10, in the comparative example, the turn-up occurred under the HH condition causing the turn-up to occur more easily. On the other hand, in the examples 1 and 2, the turn-up did not occur even under the HH condition. It can be seen that the drive torque is lower than that of the comparative example in the examples 1 and 2. Especially, the drive torque in the example 2 is 0.68 times the drive torque in the comparative example, which revealed that the friction force can be reduced more effectively.

### Other Embodiments

Though the present invention has been described in detail with the embodiment according to the present invention, the above embodiment is a preferred example of the present invention, and the present invention is not limited to this.

Though the photoconductor 41 has been taken as an example of the image carrier in the embodiment, the present invention is not limited to this. The present invention can be applied to the intermediate transfer belt T as the image carrier, and it is possible to reduce the friction force between the intermediate transfer belt T and the belt cleaning blade 481 of the belt cleaning device 48.

In such a configuration, the rotation shaft of the intermediate transfer belt T indicates the rotation shaft of the secondary transfer opposing roller 461 or the like tensioning the intermediate transfer belt T, and the belt cleaning blade 481 is moved in the direction parallel to the rotation shaft of the secondary transfer opposing roller 461 or the like.

According to the above description, as the computer readable medium including the program according to the present invention, examples using a nonvolatile memory or a hard disk are disclosed but the present invention is not limited to the above examples. For example, a portable recording medium such as a CD-ROM can be applied as the computer readable medium. A carrier wave is also applied as the medium to provide data of the program according to the present invention through the communication lines.

The detailed configuration and the detailed operation of the devices included in the image forming apparatus can be suitably changed without departing from the scope of the present invention.

Although embodiments of the present invention have been described and illustrated in detail, the disclosed embodiments are made for purposes of illustration and example only and not limitation. The scope of the present invention should be interpreted by terms of the appended claims.

What is claimed is:

1. An image forming apparatus comprising:
an image carrier that carries a toner image to be transferred to a sheet;
a cleaner that contacts a surface of the image carrier and removes a toner, the cleaner being located at a first position while a rotation of the image carrier is stopped and the cleaner being located at a second position during the rotation of the image carrier;
a moving mechanism that moves the cleaner between the first position and the second position by moving the cleaner in a direction parallel to a rotation shaft of the image carrier while a contact state between the cleaner and the image carrier is maintained; and
a hardware processor that controls operations of the image carrier and the moving mechanism, wherein
the hardware processor starts a movement of the cleaner from the first position to the second position with the moving mechanism while the rotation of the image carrier is stopped, and the hardware processor starts the rotation of the image carrier during the movement of the cleaner.

2. The image forming apparatus according to claim 1, wherein the hardware processor outputs a rotation signal for rotating the image carrier to the image carrier and outputs a movement signal for moving the cleaner to the moving mechanism, the movement signal being independent from the rotation signal.

3. The image forming apparatus according to claim 1, wherein the first position and the second position are switched to each other each time the rotation of the image carrier is stopped.

4. The image forming apparatus according to claim 3, wherein the cleaner is fixed and held at the second position during the rotation of the image carrier.

5. The image forming apparatus according to claim 3, wherein the cleaner is a cleaning blade in a strip shape a longitudinal direction of which is a shaft direction of the image carrier, the cleaner has a first side that extends in the longitudinal direction and contacts the surface of the image carrier, a second side that is located at one end in the longitudinal direction and orthogonal to the first side, and a third side that is located at the other end in the longitudinal direction and orthogonal to the first side, a first end portion is formed between the first side and the second side, a second end portion is formed between the first side and the third side, and each of the first end portion and the second end portion has a round shape.

6. The image forming apparatus according to claim 1, wherein the cleaner is always located at one of the first position and the second position each time the rotation of the image carrier is stopped.

7. The image forming apparatus according to claim 6, wherein the hardware processor starts moving the cleaner from the second position to the first position with the moving mechanism during the rotation of the image carrier.

8. The image forming apparatus according to claim 6, wherein the cleaner is a cleaning blade in a strip shape a longitudinal direction of which is a shaft direction of the image carrier, the cleaner has a first side that extends in the longitudinal direction and contacts the surface of the image carrier, a second side that is located at one end in the longitudinal direction and orthogonal to the first side, and a third side that is located at the other end in the longitudinal direction and orthogonal to the first side, a first end portion is formed between the first side and the second side, and a second end portion is formed between the first side and the third side, and at least an end portion located on a distal end side in a moving direction from the first position to the second position among the first end portion and the second end portion has a round shape.

9. The image forming apparatus according to claim 1, further comprising:
a collector that collects the toner which is removed by the cleaner; and
a seal that includes an elastic body and fills a gap between the collector and each of a first end portion and a second end portion of the cleaner, wherein
the cleaner is a cleaning blade in a strip shape a longitudinal direction of which is a shaft direction of the image carrier, the cleaner has a first side that extends in the longitudinal direction and contacts the surface of the image carrier, a second side that is located at one end in the longitudinal direction and orthogonal to the first side, and a third side that is located at the other end in the longitudinal direction and orthogonal to the first side, the first end portion is formed between the first side and the second side, and the second end portion is formed between the first side and the third side, and the cleaner is located at the first position or the second position, and both of the first end portion and the second end portion are pressed into the seal.
